(19) United States
(12) Patent Application Publication
(10) Pub. No.: US 2013/0078602 A1
(43) Pub. Date: Mar. 28, 2013

(54) Clothing Connector Educational Book

(71) Applicant: Betty Jane Lubbers, Coral Gables, FL (US)

(72) Inventor: Betty Jane Lubbers, Coral Gables, FL (US)

(21) Appl. No.: 13/623,939

(22) Filed: Sep. 21, 2012

Related U.S. Application Data
(60) Provisional application No. 61/538,455, filed on Sep. 23, 2011.

(51) Int. Cl. G09B 19/00

(52) U.S. Cl. 434/257

(57) ABSTRACT

Disclosed is a children's educational tool and activity device. The device comprises a book having a plurality of rigid pages sandwiched between a front and back covering and connected along a central binding. The pages comprise fabric covered board material having a first and second crocheted material flap representing an article of clothing. The flaps are connected to the page along one edge and aligned with one another along an opposite edge. A clothing connector element joins the flaps along a line of connection that establishes a union between the flaps. Each page represents a different connector element that allows a child to visualize, handle and manipulate, while the colors of the page, flaps and connector element are distinct to teach recognition of each element.

### CROSS REFERENCE TO RELATED APPLICATION

This application claims the benefit of U.S. Provisional Application No. 61/538,455 filed on Sep. 23, 2011, entitled “I Can Do It Fabric Activity Book.” The above identified patent application is herein incorporated by reference in its entirety to provide continuity of disclosure.

### BACKGROUND OF THE INVENTION

1. Field of the Invention

The present invention relates to interactive books, dexterity building tools and children's educational books. More specifically, the present invention pertains to a book having pages that include two ends of clothing fabric and different types of clothing securement means on each page to teach children how to manipulate various clothing items, knots and related devices on their own and with minimal supervision.

Young children and toddlers are generally dressed and clothed by their caretakers, as the children are often too young to don the clothing by themselves and without assistance. As a child grows older, a spirit of independence and improved fine motor skills combine to drive the child to dress themselves, often rejecting outside help. The child's dexterity and fine motor skills improve with time and practice, while the sense of independence similarly grows with age. However, sometimes this sense of independence exceeds the child's ability to actually secure the clothing in practice. This can cause problems when the child is still learning to operate buttons and zipper clasps while the parent wishes to expediently dress the child. The child's wish to dress without assistance or interference often clashes with the parent's wish to dress the child for an activity or at the beginning of the day. A compromise from one party must ensue to allow for the more urgent need.

The address this problem, the present invention discloses a clothing and fine motor skills education book that is adapted to teach young children common clothing securement articles, such as snaps, buttons, zippers, tie laces and other common closure articles. The device comprises a turn-page book having a specific article of clothing and means of securement on each subsequent page, increasing in difficulty from front to back. Each page includes a fabric overlaid onto a backer material, while a pair of knitted or crocheted clothing flaps forming ends of clothing is connected to the page with a means of securement therebetween. In this way, the child is able to manipulate, handle and operate the buttons, snaps and other clothing securement articles present in the book for the purpose of practicing dressing. The device is adapted to provide contrasting primary colors to differentiate different elements on each page, while the construction of the book is one of simple materials that are comfortable to the touch for young children.

2. Description of the Prior Art

Devices have been disclosed in the prior art that relate to child education tools and books. These include devices that have been patented and published in patent application publications. The forgoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 7,090,500 to Guttman discloses an educational game for a child that teaches color recognition and manipulation of different strap connectors. The device comprises a game board of rectangular shape, a first group of straps being located along one edge, and a second group of straps being located along an opposing end of the board. At the end of each strap is a distinct connector element, the strap element having a complimentary element along a strap along the opposing edge. The each strap along the edge has a unique connector such that only one pair of straps are connectable. The straps include a color pattern that allows the user to align the correct connectors together based on strap color. The device provides a color recognition and dexterity education tool for a child. The present invention, by contrast, provides a book having a plurality of different connectors, ties, and clothing articles that allow a child to manipulate and operate a plurality of common clothing article connectors for educational purposes with little to no supervision.

U.S. Pat. No. 4,017,984 to Bonfigli is another such device that discloses a shoe tying educational device that comprises a pair of panel members attached to a base to simulate the sides of a shoe, the panels having lace holes therealong and adapted to accept a shoe lace therethrough for tying the members together in a similar fashion as a shoe. Crossed lines and operation numbers are placed on the base to teach a child to property tie a knot, facilitating later tying of one's shoe without assistance. While providing an educational device that teaches shoe tying, the Bonfigli device fails to disclose the novel aspects of the present clothing connector book, which teaches manipulating and handling of various connector elements commonly found on child's clothing.

U.S. Pat. No. 4,096,647 to Barry discloses a learn-to-dress manual that comprises a flat base, a shoe top including lacings, and a plurality of superimposed pairs of stain and tear resistant panels to simulate garment members centrally divided on a pair of panels. Each successive panel presents an exercise of increasing complexity for training purposes. The device of Barry represents a training device having clothing items wherein the items are provided on separate pages or base surfaces, and a connector element is provided to cross the divided pages. The present invention contemplates a differing construction and one of diverging elements of that of Barry.

Further, U.S. Pat. No. 2,972,820 to Cano discloses a dexterity training device that comprises a sheet formed of separate layers of pliable material jointed along a common edge, a plurality of fastening means along each sheet for manual manipulation, and a carrying strap releasably secured to the sheet for transport in a folded or unfolded configuration. The device comprises a folded sheet of material having various clothing connectors thereon, including belt buckles, shoe laces and zipper clasps closures. The Cano device provides such a structure on a folded layer of material, while the present invention provides a child's book that includes such structures on different pages and in a form conducive for use by young children.

U.S. Pat. No. 2,501,902 to Howell discloses an educational toy comprising a book having a plurality of pages, each page includes a figure on the page and fragment of clothing elements and interengaging fastening elements on the clothing elements for each figure. Similarly, U.S. Pat. No. 2,527,242 to Clark discloses a device for teaching a child successive manipulations required for dressing and undressing. The Howell book includes a figure that is dressable using the fragments of clothing, along with hair that may be combed and hands that may be donned with gloves. The device is adapted as a child's toy for dressing dolls. The Clark book comprises a plurality of pages having two relatively movable page portions formed as complimentary parts of wearing apparel, along with a fastening means along the apparel line of connection to unite and separate the parts. Both the Howell and Clark books disclose devices of similar intent, while their structure and construction differ from that of the present invention. The present invention contemplates a crocheted material overlaid over a board material forming pages of a book, wherein the material, coloring and the connector elements are directed for young children with developing recognition and motor skills.

The present invention provides an educational device that is designed to provide both tactile and visual input for a child user, while providing flaps of material that include enlarged closure means typically found in child clothing, including buttons, snaps, zip fasteners and other common clothing securement methods. The structure of the book and its elements are submitted as being substantially divergent in design elements from the prior art, and consequently it is clear that there is a need in the art for an improvement to existing child education devices. In this regard the instant invention substantially fulfills these needs.

### SUMMARY OF THE INVENTION

In view of the foregoing disadvantages inherent in the known types of educational motor skills devices now present in the prior art, the present invention provides a new clothing connector education book directed to a child learner that can be utilized for providing a teaching tool for the child when learning to manipulate clothing and recognizing different clothing closure means.

It is therefore an object of the present invention to provide a new and improved educational child motor skills device that has all of the advantages of the prior art and none of the disadvantages.

It is another object of the present invention to provide an educational child motor skills device that provides a multi-page book having pages of child clothing and connector elements for teaching manipulation of the elements and recognition of their operation.

Another object of the present invention is to provide an educational child motor skills device comprising of a book having pages constructed of fabric covered board material, wherein each page includes a pair of knitted or crocheted material flaps that engage one another using a unique connector element on each page.

Yet another object of the present invention is to provide an educational child motor skills device that utilizes easily manipulated, thickened fabric clothing flaps that include corresponding connector elements, while providing different primary colors for each element of the page (fabric covering, clothing material and connector elements).

A final object of the present invention is to provide an educational child motor skills device that is of simple construction and of low cost to reproduce.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a view of a button embodiment of the present invention.

FIG. 2 shows a view of a zip fastener embodiment of the present invention.

FIG. 3 shows a view of a tie string embodiment of the present invention.

FIG. 4 shows a view of a hook and loop fastener embodiment of the present invention.

FIG. 5 shows a view of a hook and eye embodiment of the present invention.

FIG. 6 shows a view of a snap embodiment of the present invention.

FIG. 7 shows a view of a belt embodiment of the present invention.

FIG. 8 shows a view of a suspender buckle embodiment of the present invention.

### DETAILED DESCRIPTION OF THE INVENTION

Reference is made herein to the attached drawings. Like reference numerals are used throughout the drawings to depict like or similar elements of the educational child motor skills device. For the purposes of presenting a brief and clear description of the present invention, the preferred embodiment will be discussed as used for improving fine motor skills and visual recognition of clothing elements for a young child when learning to dress themselves. The figures are intended for representative purposes only and should not be considered to be limiting in any respect.

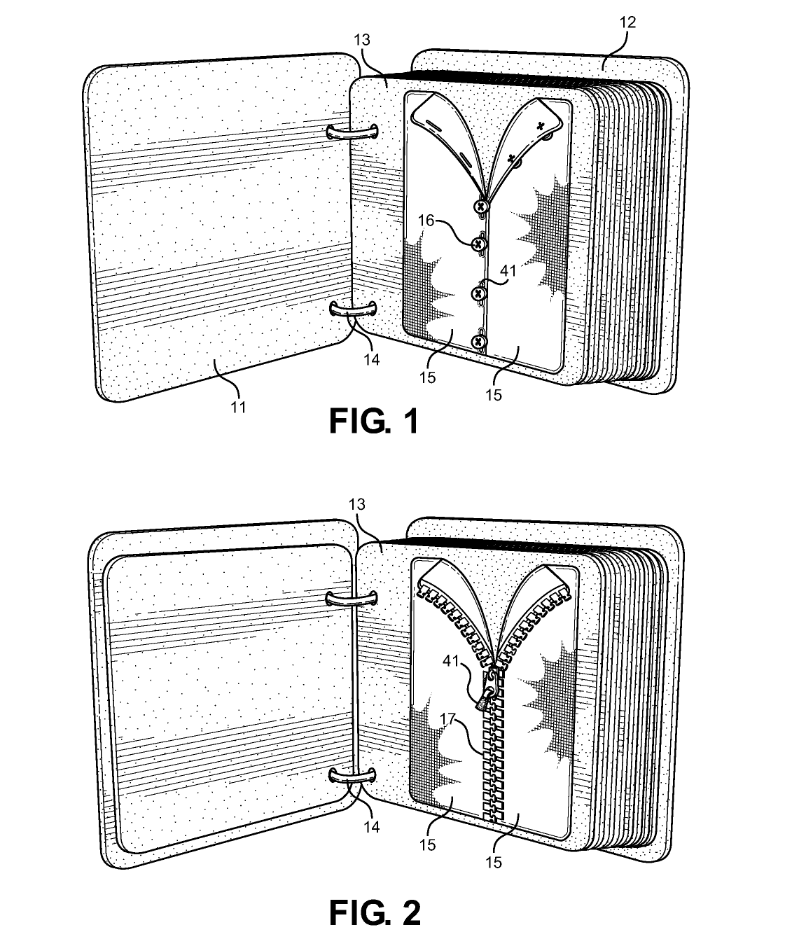

Referring now to FIG. 1, there is shown a perspective view of the present invention. The device is an instructional and educational tool that teaches young children to become familiar with clothing articles and the means of connection commonly found on their own clothing. A young child can learn to be self-proficient in dressing by engaging the elements of the present invention, whereby donning and securing clothing articles becomes a more familiar exercise and the handling of the associated connector elements is a practiced activity. The goal of the present invention is two-fold: to provide an activity book that entertains young children, while also providing an educational tool that allows young children to learn new skills as they reach the age of clothing themselves. Young children can develop strong motivations to clothe themselves, based on their observations of older siblings or parents, and the general feeling or wanting of independence from parents and caretakers. It is common that children sometimes refuse help during certain activities and become determined to master the activity without supervision or assistance. This is rewarding for the parents, as the child is becoming more self-reliant while relieving the parent of additional activities, but it can also be burdensome if the child is not fully capable of dressing and the activity becomes fruitless. The present invention provides an educational tool that builds confidence and fine motor skills such that a child can practice securing clothing, while at the same time being occupied and entertained, whereafter a time the activity becomes second nature and the child is capable of clothing him or herself.

Numerous activities can build fine motor skills; however the present invention is directed to teaching clothing connectors. The elements of the invention provide a means for the child to readily recognize and manipulate such structures such that the gap between the learning tool and the activity of clothing oneself is easily overcome, or at least is readily obvious to the child. It is therefore contemplated to disclose a book that is comfortable to handle, colorful in its presentation, and includes materials that are recognizable when transferring the newly founds skills to clothing articles being donned. It is further contemplated to disclose a child's educational tool that is readily produced with low costs of construction, whereby the cost of purchased transferred to the consumer is reduced for widespread distribution.

Referring again to FIG. 1, there is shown an embodiment of the present invention that highlights the primary function and purpose of the disclosure, while also presenting its construction. The device comprises a book having a plurality of rigid pages connected to a common book binding or connector 14. Each page comprises a backing layer 13 that is of a board structure covered by a fabric covering, upon which is attached a pair of adjacent clothing flaps 15 having an edge attached to the fabric covering and an opposing, unattached side adapted to be joined and un-joined from the adjacent flap 15 along a line of connection. The pages 13 are stacked upon one another and sandwiched between a front book cover 11 and a rear back cover 12. Along the flap material line of connection is a clothing connector element, which changes from page to page to present different connector elements throughout the book. The different connectors provide a teaching tool to a child learning the different and common means of securing clothing together.

The material of the clothing flaps is preferably a knitted or crocheted material of considerable thickness that a child can easily grasp the fabric with minimal motor skills and with minimal bunching if the child squeezes the fabric. Thicker, crocheted yarn material allows for improved grip, as it is more easily handled with smaller hands and more pliable than thinly sewn fabric sheet material. The clothing flap material 15 is sewn to the fabric page covering 13 along an outer edge of the flap, while the interior edge for both flaps 15 creates a line of connection that is unionized with a connector element easily manipulated and handled by a child with small hands and undeveloped fine motor skills. The color of each element on the page is also an important aspect with respect to building recognition of each connector and its function. It has been shown that young children respond positively to primary colors, where coordinating specific colors for specific elements of each page will invite the child to manipulate the elements, learn through recognition and stimulate the learning aspect of the child's brain. It is contemplated that the page coverings be a blue material, while the clothing flaps are a navy blue and each connector element is provided in red. In this fashion, the child readily recognizes what is the operable connector element to be manipulated from page to page. Upon recognition, the child can learn how each specific connector element functions. Further facilitating this recognition is the use of colored appliqués at each connector element location. The appliqués are small adornments that signify what elements are to be joined, pulled or operated to facilitate securing of the connector element together and therefore securing the clothing flaps together.

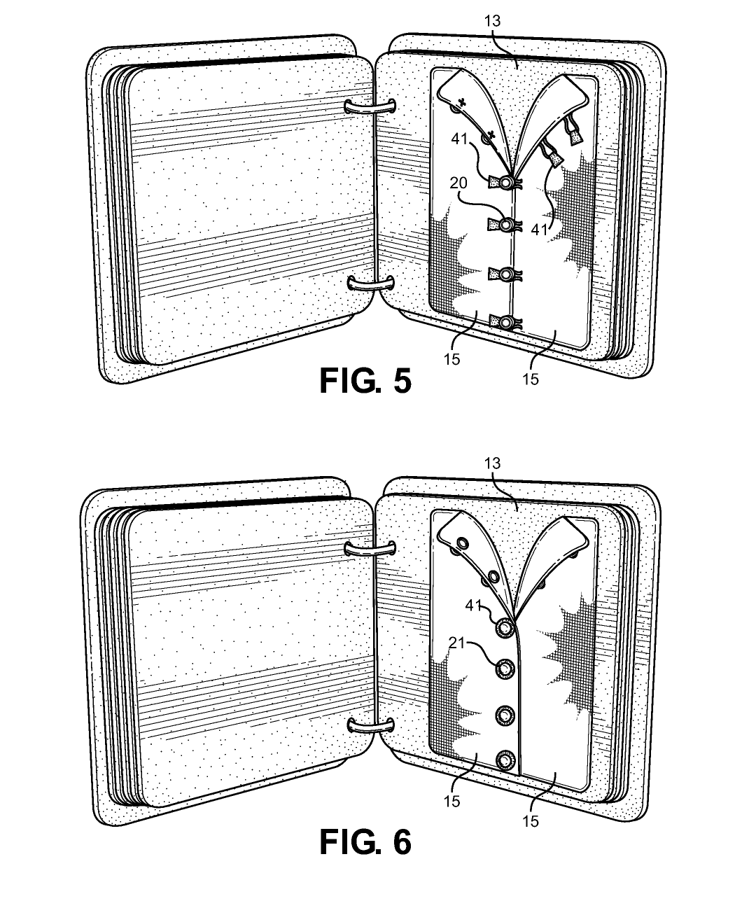

Referring to FIGS. 1 through 6, there are shown the embodiments of the present invention and its contemplated connector elements. The embodiments shown include button and button hole connector elements 16, zip fastener connector elements 17, tie or draw string elements 18, hook and loop fastener elements 19, and finally hook and eye connector elements 20. Further contemplated are snaps connector 21 elements and a belt 22 embodiment. The button and button hole embodiment 16 includes sewn buttons along one flap and corresponding and reinforced button slots along the adjacent flap. Each of the button holes include a surrounding appliqué 41 in which to signify to the child where the buttons are placed. The zip fastener 17 embodiment contemplates a line of interlocking teeth along corresponding edges of the flaps that are joined and un-joined by a sliding zip clasp slider element. The clasp of the zipper includes a pull tab 41 with an appliqué thereon. The tie string 18 embodiment contemplates a string that is woven between corresponding loops or holes in the adjacent flaps, establishing a connector that can be tightened and tied together for securement. Each string includes a similar pull tab-style element 41 at its terminal end. The hook and loop fastener embodiment contemplates complimentary strips of hook and loop fastening material along the underside of each flaps' line of connection. Appliqués 41 are placed along the exterior of the outer flap 15 to signify the placement of each hook and loop fastener strip or discrete location. Finally, The snap 21 embodiment and the hook and eye 20 embodiments contemplate a structure similar to the button and hole 16 embodiment, wherein the buttons and holes are replaced by complimentary snap elements or buttons and looped material having appliqués or similar pull tab marker elements 41.

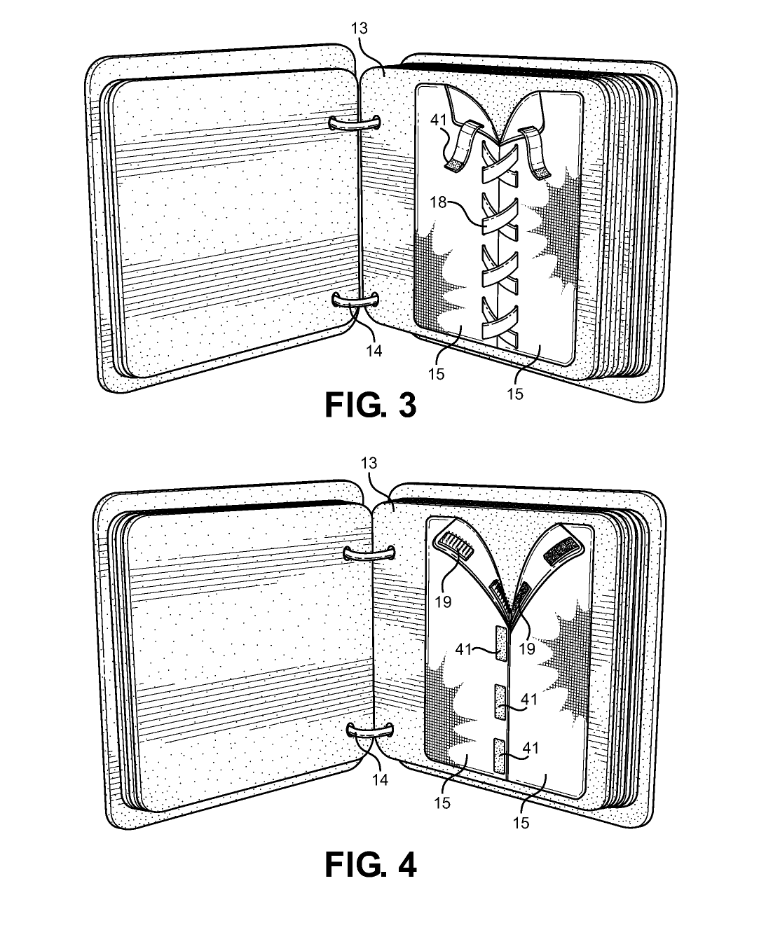

The tie string embodiment of FIG. 3 includes a first and second tie string 18 that is woven between the two crocheted or knitted fabric flaps 15 through adjacent through-holes. The terminal ends of the strings include pull tabs or appliqués 41 to highlight for the child what element to manipulate when pulling, tying or otherwise securing the flaps together using the string 18. It is preferred to provide a first and second string that includes one red string and one white string, where the colors contract one another as they are woven between the flaps 15 and illustrate to the child how the strings operate to secure the flaps 15 together.

The hook and loop fastener embodiment of FIG. 4 includes an outer flap and an underside flap, where the two flaps overlap one another along their line of connection. The line of connection provides for a continuous strip of hook and loop fasteners, discrete patches of fasteners or a discontinuous set of strips 19 that function as discrete connector elements. Appliqués 41 are placed along the outer flap along each hook and loop fastener strip location, signifying to the child the location having a securement element. It is desired to provide an appliqué or market element 41 on each connector embodiment and on each page of the present device, whereby the element 41 serves as a ready indictor of the location for each connector element. This element 41 may be formed of a different color than the material flaps, or may further include a particular adornment that is visually recognizable.

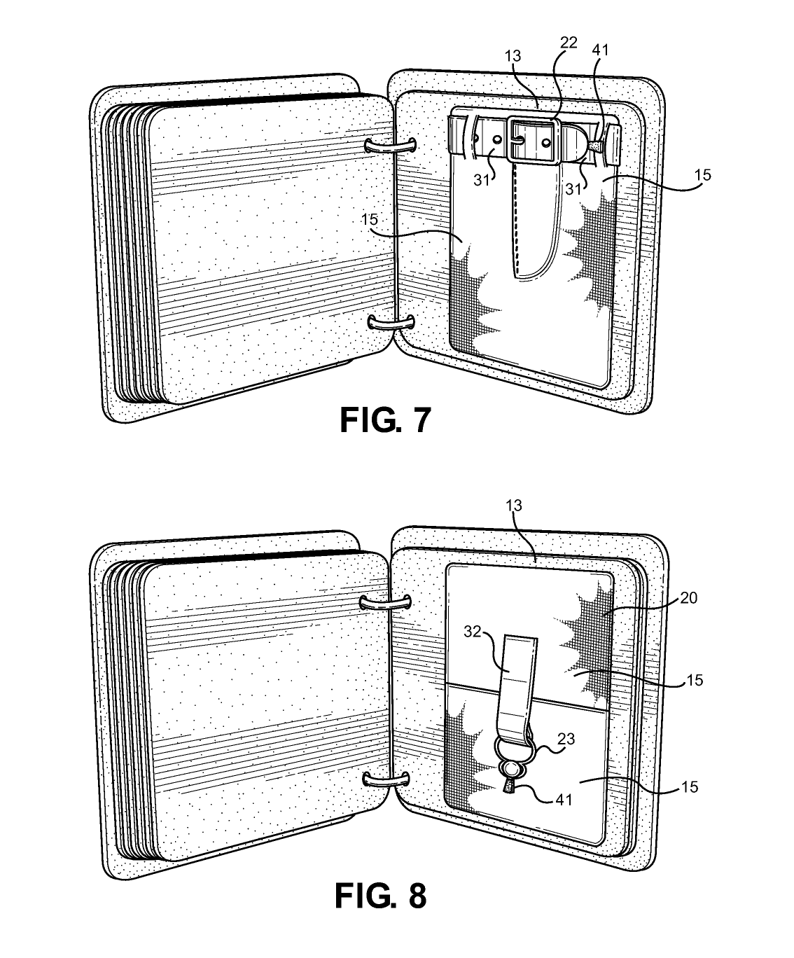

Referring now to FIG. 7, there is shown a belt buckle embodiment of the present invention, which comprises a plurality of belt loops supporting a first and second belt strap 31 and a belt strap connector 22 therebetween. This embodiment is designed to teach a child to handle a belt buckle 22, which is a more advanced embodiment over other connectors found on a most children's clothing. The flaps 15 are be completely or partially disconnected to create a separable line of connection, wherein the belt and belt buckle are utilized to secure the line of connection together as with a pair of paints. A pull tab 41 or similar marker element allows the child to recognize the operable element of the belt during use. Finally, and shown in FIG. 8, a suspender buckle embodiment contemplates the material flaps 15 being vertically stacked, wherein the upper flap includes a downward hanging strap 32 having looped connector clasp 23. At least one strap connector buckle 23 secures over a snap along the lower material flap 15 in a similar fashion as a child's overalls suspender strap. Similar to the belt buckle embodiment, a market element 41 is provided on the operable connector buckle 23 of the suspender embodiment.

It can be difficult and frustrating for children to learn how to dress themselves independently of their parents or guardians. Parents often have trouble explaining to their children how to button, tie, buckle, and affect connection of these connector elements that are otherwise obvious to grown individuals. Many children do not respond well to their parents' teachings because they want to perform the tasks by themselves. The entire process can be discouraging and result in delays in the child's development and growth. The present invention is a book having knitted or crocheted clothing flaps and corresponding connector elements that allow children to handle clothing and learn to manipulate common clothing connectors. The overall purpose is to both entertain a child and help teach the child how to dress themselves. Each page in the book has a different activity on it, such as buttoning, zippering, snapping, tying, connecting, buckling and suspending. The purpose of the book is to eliminate the frustrations and difficulties that young children face when learning how to master the tasks needed to dress themselves. The book allows parents to coach their children in the skills necessary for dressing, while also enabling the children to practice their skills independently. The colors deployed for each element are specifically outlined to improve visualization for young children, where it is contemplated that different primary colors are utilized for each element on a page.

The present invention entertains and instructs young children how to accomplish tasks related to dressing, such as zippering, tying, and the like. The invention is comprised of a thick, knitted or crocheted fabric activity book having rigid pages covered in fabric and flaps of material of sufficient thickness and material for easy handling. It has been shown that children respond well to primary colors; therefore it is desired to disclose the present children's book using alternating primary colors for specific elements. For instance, the page fabric may be blue, while the clothing flaps are a darker blue and the connector elements are all red. An appliqué or market element is provided at each operable connector location, providing the child with an indication of each connector element location and what elements are to be manipulated to form a union between clothing flaps. Other iterations of color combinations are contemplated, falling within the scope of the present invention. Each page has a different activity for the child, each allowing the parent to demonstrate to the child how to complete each task and allow the child to practice independently.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A children's educational device, comprising:
a book having a front cover, rear cover, a plurality of pages therebetween and a means of connecting said pages and cover together along a common edge;
said pages having a rigid board construction, a fabric covering thereover, a first and second material flap and a clothing connector means between said flaps;
said flaps being positioned adjacent to one another to create a line of connection, said flap being connected to said fabric covering along an outside edge opposite of said line of connection;
said clothing connector means joining said flaps along said line of connection;
said pages each having different clothing connectors for successive pages.

2) The device of claim 1, wherein said material flaps are a crocheted material that is soft and thick for manipulation and grip of a young child.

3) The device of claim 1, wherein said material flaps are a knitted material that is soft and thick for manipulation and grip of a young child.

4) The device of claim 1, wherein said material flaps, clothing connector and fabric covering material are different colors to highlight different elements on each page.

5) The device of claim 1, where a marker element is provided at each of said connector element for visualization of each operable connector element.

6) The device of claim 5, where a marker element further comprises an appliqué.

7) The device of claim 5, where a marker element further comprises a pull tab element.

8) The device of claim 1, wherein one of said connector elements is a button and button hole connection along said line of connection.

9) The device of claim 1, wherein one of said connector elements is a zip fastener connector along said line of connection.

10) The device of claim 1, wherein one of said connector elements is a tie lace adapted to weave through lace holes along said line of connection.

11) The device of claim 10, wherein said tie lace further comprises a first and second tie lace having a first and second color.

12) The device of claim 1, wherein one of said connector elements are corresponding hook and loop fasteners along said line of connection.

13) The device of claim 12, wherein said hook and loop fasteners comprise a continuous strip of hook and loop fasteners.

14) The device of claim 12, wherein said hook and loop fasteners comprise discontinuous patches of hook and loop fasteners.

15) The device of claim 1, wherein one of said connector elements is a plurality of snaps along said line of connection.

16) The device of claim 1, wherein one of said connector elements is a plurality of hook and eye connectors along said line of connection.

17) The device of claim 1, wherein said connector element is a first and second belt strap having a belt buckle and belt buckle receiving portion attached across said line of connection.

18) The device of claim 1, wherein:
said first and second flap being vertically stacked, said first flap being above said second flap;
at least one strap connected to said first flap and extending to said second flap and terminating at a looped securement means;
said flap looped securement means adapted to secure around a snap attached to said second flap.
